(19) United States
(12) Patent Application Publication
(10) Pub. No.: US 2015/0317092 A1
(43) Pub. Date: Nov. 5, 2015

(54) DISK ARRAY SYSTEM AND CABLE INFORMATION SETTING METHOD

(71) Applicant: HITACHI, LTD., Tokyo (JP)

(72) Inventors: Tomoki TANOUE, Tokyo (JP); Hiroshi SUZUKI, Tokyo (JP); Masato OGAWA, Tokyo (JP)

(21) Appl. No.: 14/368,022

(22) PCT Filed: Jan. 17, 2013
(86) PCT No.: PCT/JP2013/050861

§ 371 Date: Jun. 23, 2014

(51) Int. Cl. G06F 3/06

(52) U.S. Cl. CPC G06F 3/0619; G06F 3/0635; G06F 3/0683

(57) ABSTRACT

There is provided a disk array system including an EXP (Expander) for connecting a plurality of memory devices in a daisy chain fashion, through a plurality of cables in which CC (electrical signal cable) and AOC (optical signal cable) are mixed. The EXP accesses a cable built-in MEM, determines whether the cable is CC or AOC from the acquired CABLE information, sets the appropriate protocol and parameters based on a determination result, identifies the EXP requiring a frame-to-frame connection based on an SAS address, and acquires the CABLE information only for the cable to be connected to the EXP to make an appropriate setting.

### TECHNICAL FIELD

The present invention relates to a disk array system and a CABLE information setting method in the disk array system. More particularly, the present invention relates to a setting method of CABLE information when the type of the cable is different depending on the section of the transmission path.

### BACKGROUND ART

When the data transmission rate of a storage interface in a disk array system increases, the signal frequency also increases. As a result, the influence of the attenuation and reflection of the signal in the transmission path increases, so that it tends to be difficult to maintain the signal quality. This tendency is particularly significant for the SAS 2.0 standard in which the data transmission rate is 6 Gbps. There is a technology for maintaining the signal quality by setting parameters, such as the amplitude value (the proper value of the amplitude) of the output signal of a transmission LSI (large Scale Integration) as well as the emphasis (correction of the frequency characteristics, in particular, in the high frequency region), to appropriate values. The appropriate values of the parameters are different depending on the characteristics of the transmission path.

There are a plurality of transmission paths that are connected by a storage interface. For example, there is a transmission path that connects an EXP (Expander, which has a function of allowing connection of a larger number of end devices than the number of ports such as SAS Controllers, and a function of amplifying the signal attenuated in the transmission) mounted on an SSW (SAS-Switch) substrate, and a HDD (Hard Disk Drive) to each other. Another example is a transmission path that connects EXPs mounted on different PCBs (Printed Circuit Boards) by a CC (Copper Cable). With respect to the path for connecting the EXP and the HDD, there are different transmission paths for the number of HDDs that can be mounted on one substrate. Also in the CC connection, there are a plurality of transmission paths within the CC. Further, even in the same transmission path, the characteristics of the transmission path are different depending on the cable length. Patent Documents 1 and 2 are known to support these different transmission paths.

Patent Document 1 describes a technology for reading parameters from mounted drives to set the parameters corresponding to the mounting position of each drive.

Patent Document 2 describes a technology for identifying the physical positions of EXPs, identifying the cable length of the CC between the EXPs, and setting the appropriate parameters.

Further, Patent Document 3 is also known as a technology for automatically correcting the loss of the cable.

### PRIOR ART DOCUMENT

### Patent Document

Patent Document 1: US Patent Application Publication No. 2011/0252195

Patent Document 2: U.S. Pat. No. 8,190,790

Patent Document 3: Japanese Patent Laid-Open Publication No. 2002-124893

### SUMMARY OF INVENTION

Cable types supported by the SAS 2.0 standard and by the SAS 2.1 standard and subsequent standards are shown in FIG. 1. The SAS 2.0 standard, which supports only CC, does not have a memory within the cable. However, after SAS 2.1, the SAS standard supports CC and AOC (Active Optical Cable) and has a memory within the cable. In the case of the AOC as compared to the CC, the transmission loss within the cable is small and the cable can be extended. Thus, the use of the AOC can increase flexibility of the storage case layout. However, in general, AOC is more expensive than CC. For this reason, in the cable-to-cable connection between EXPs, the CC connection is used for the section allowing a short-range connection, and the AOC is only used for the section requiring a long-range connection. In other words, it is necessary to use both CC and AOC on the same substrate in order to achieve effective storage layout operations including costs.

When both CC and AOC are present in a transmission path of a disk array system, a transmission error may occur unless appropriate parameters are not set for each of the CC and the AOC. In particular, the AOC may produce a protocol error if an appropriate protocol setting is not made. Thus, it is necessary to identify the CC and the AOC. In the disk array system, a plurality of EXPs are connected in a daisy chain (connection in a bucket-brigade manner) through a plurality of cables, so that it will take time for setting by acquiring CABLE information from all the cables.

Accordingly, an object of the present invention is to solve the above problem.

### Solution to Problem

In order to solve the above problem, according to the present invention, there is provided a disk array system in which an EXP performs the following operations to connect a plurality of disks in a daisy chain fashion through a plurality of cables including CC and AOC.

The operations include accessing a cable built-in MEM, determining whether the cable is CC or AOC from the acquired CABLE information, and setting the appropriate protocol and parameters based on the determination result. Further, the operations also include identifying the EXP that requires a connection between cases based on the SAS address, acquiring the CABLE information of the cable to be connected to the particular EXP, and making the appropriate setting.

### Advantageous Effects of Invention

According to the present invention, even if CC and AOC are mixed in a transmission path of a disk array system, it is possible to set the appropriate parameters for the CC and the AOC to the EXP.

### BRIEF DESCRIPTION OF THE DRAWINGS

FIG. 1 is a view showing the correspondence between SAS standards and supported cable types.

FIG. 2A is a schematic diagram showing a transmission path of a CC connection.

FIG. 2B is a schematic diagram showing a transmission path of an AOC connection.

FIG. 3 is a view showing the comparison of the attenuation characteristics in the range of EXP-CC connection-EXP and the range of EXP-AOC.

FIG. 4 shows the device configuration of a disk array system.

FIG. 5 is a block diagram of a drive box.

FIG. 6A is a schematic diagram showing the configuration of a cable connection by CC.

FIG. 6B is a schematic diagram showing the configuration of a cable connection by AOC.

FIG. 7 is a view showing a process flow of CABLE information acquisition.

FIG. 8 is a view of an example of CABLE information.

FIG. 9 is a view showing a process flow of appropriate protocol and parameter setting.

FIG. 10 is a view of an example of the setting information.

FIG. 11 is a view of an example of CABLE information storage table.

FIG. 12 is a process flow for setting a plurality of CTL-EXP paths.

FIG. 13A is a view showing the outline of the process of CABLE information acquisition and setting (cable type identification).

FIG. 13B is a view showing the outline of the process of CABLE information acquisition and setting (setting information acquisition).

FIG. 13C is a view showing the outline of the process of CABLE information acquisition and setting (setting information setting).

FIG. 14 is a diagram showing an example of the connection between frames.

FIG. 15 is a view showing an example of CABLE information acquisition necessity determination table.

FIG. 16A is a view of a format of SAS address.

FIG. 16B is a view of an example of SAS address.

FIG. 17 is a flow chart for determining information acquisition necessity from the SAS address.

FIG. 18 is a view of an automatic switching flow when the CABLE information is not acquired.

FIG. 19 is a view of an example of the standard correspondence table for AOC.

FIG. 20 is a view showing an operation flow of SAS 2.0 based CTL/EXP and SAS 2.0 compliant AOC.

### DESCRIPTION OF EMBODIMENTS

When AOC is used for a transmission path of a disk array system for implementing the present invention, it is necessary for the AOC connection to make the appropriate protocol setting (the protocol corresponding to the data transmission method, in particular, the idle method). For example, the SAS standard has the status (D.C. Idle) in which the electrical signal level is 0 (direct current). When the cable is CC, the D.C. Idle can be transmitted as it is. However, when the cable is AOC, the signal of level 0 may not be transmitted. Thus, instead of D.C. Idle, it is necessary to generate an alternating current signal with a specific wave pattern and transmit the generated AC signal.

Previously until the SAS 2.0 standard, the protocol includes the signal only based on the CC connection. However, in general, the AOC connection may not be established with this protocol. After the SAS 2.1 standard, the protocol is specified by the assumption of the AOC connection, so that it is possible to set the particular protocol to be used for the AOC connection.

The AOC connection requires an appropriate parameter setting (setting of the proper value of the amplitude of the output signal, as well as the emphasis). The characteristics of the transmission path are different in the CC connection and the AOC connection. Thus, it is possible to improve the signal quality by setting appropriate parameters for each of the connections.

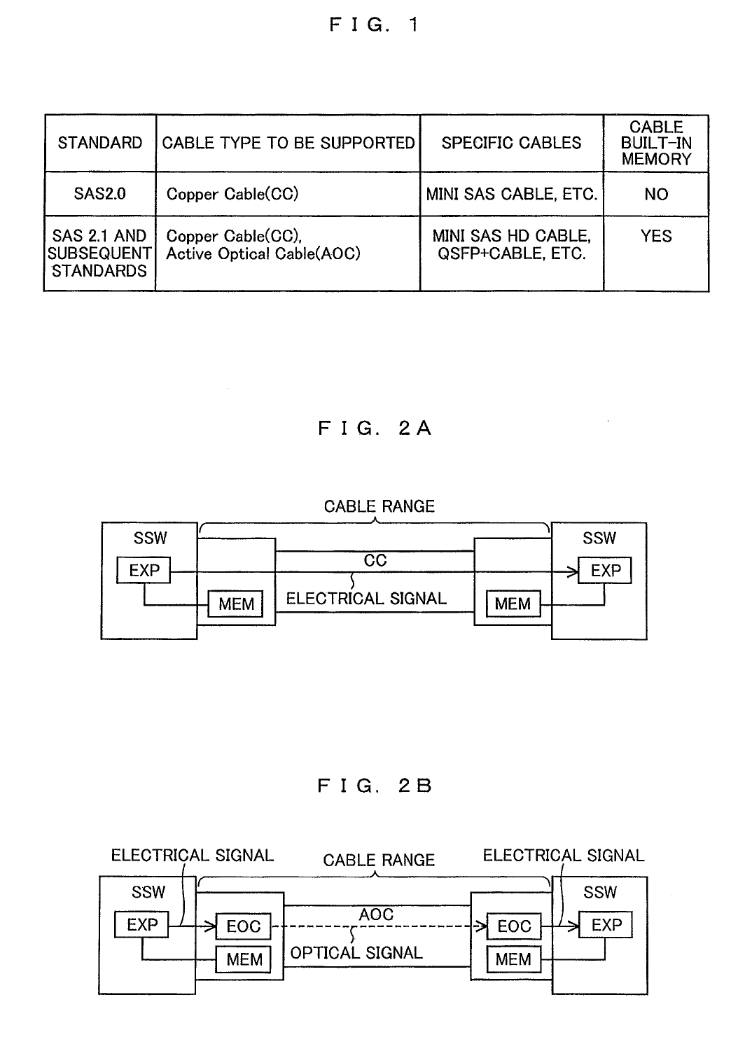

The difference in the transmission path between the CC connection and the AOC connection is shown in FIGS. 2A and 2B. The cable supported after SAS 2.1 has a built-in MEM (Memory, for example, such as a flash memory and a ROM) that is mounted in transmission and reception terminals (connectors) of the cable. In the CC connection shown in FIG. 2A, the signal output from the transmission side EXP is an electrical signal, which is directly transmitted to the reception side EXP. The presence or absence of a transmission error is determined in the reception side EXP. On the other hand, in the AOC connection shown in FIG. 2B, the signal output from the transmission side EXP is converted from the electrical signal to an optical signal in an EOC (Electrical Optical Converter) of the AOC on the transmission side SSW. The optical signal is transmitted over the cable. Then, the optical signal is converted again to an electrical signal in the EOC of the AOC on the reception side SSW. Then, the converted electrical signal is transmitted to the reception side EXP. The presence or absence of a transmission error is determined in the reception side EXP, which is the same as in the case of the CC connection. However, it is necessary for the AOC connection to properly receive the electrical signal and convert the electrical signal to the optical signal also in the transmission side EOC.

Even if the length of the cable is short, the attenuation of the CC connection is greater than the attenuation of the AOC. In order to correct such attenuation, it is necessary to appropriately set the values of the transmission signal parameters (the proper value of the amplitude, the emphasis, and the like) to the EXP. If the CC connection and the AOC connection are set to the same parameters, a signal transmission error may occur. The length of the transmission path between the EXP and the AOC on the transmission side SSW substrate is short, so that the signal is over corrected in the reception part of the EOC.

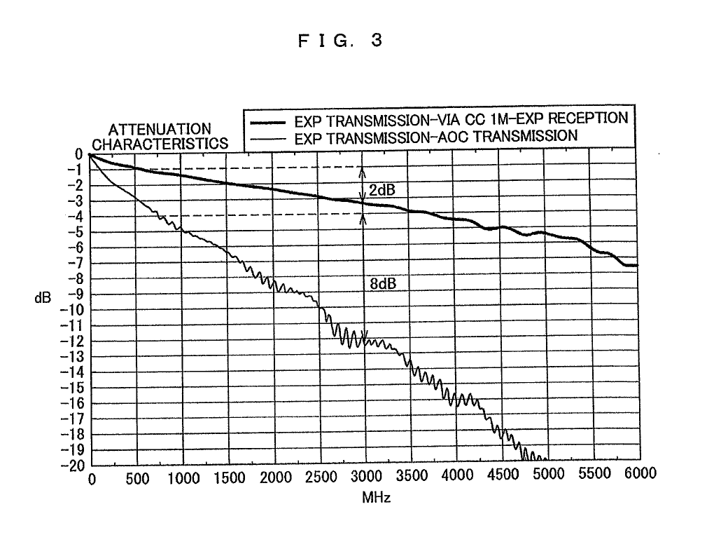

As an example, FIG. 3 shows an example comparing the attenuation characteristics in the range of EXP-CC connection-EXP (between two EXPs in the CC shown in FIG. 2) and the range of EXP-AOC (between the EXP and the EOC on the transmission or reception side in the AOC shown in FIG. 2). As compared to the case of the CC, in the case of the AOC shown in FIG. 2, the optical signal is hardly attenuated between the EOCs within the AOC. Thus, the amount of the attenuation in the case of the AOC shown in FIG. 3 does not include the amount of the attenuation between the EOCs. ISI (Inter-Symbol Interference) is caused by the difference in the attenuation of the signals in the high frequency region and the low frequency region. The parameters are set so that the difference in the attenuation is reduced. In the example of FIG. 3, the difference in the attenuation in EXP-CC connection-EXP in the range from 750 MHz (the frequency corresponding to 4 T (6 Gbps/4)) to 3000 MHz (the frequency corresponding to 6 Gbps of SAS) is about 8 dB, while the difference of the attenuation in EXP-AOC is about 2 dB. Thus, in order to maintain the signal quality, it is necessary to identify CC and AOC and to set appropriate parameters to each of the CC and AOC connections. The dashed line in FIG. 3 shows the amount of attenuation of CC and AOC of 750 MHz.

### First Embodiment

### Configuration of Disk Array System

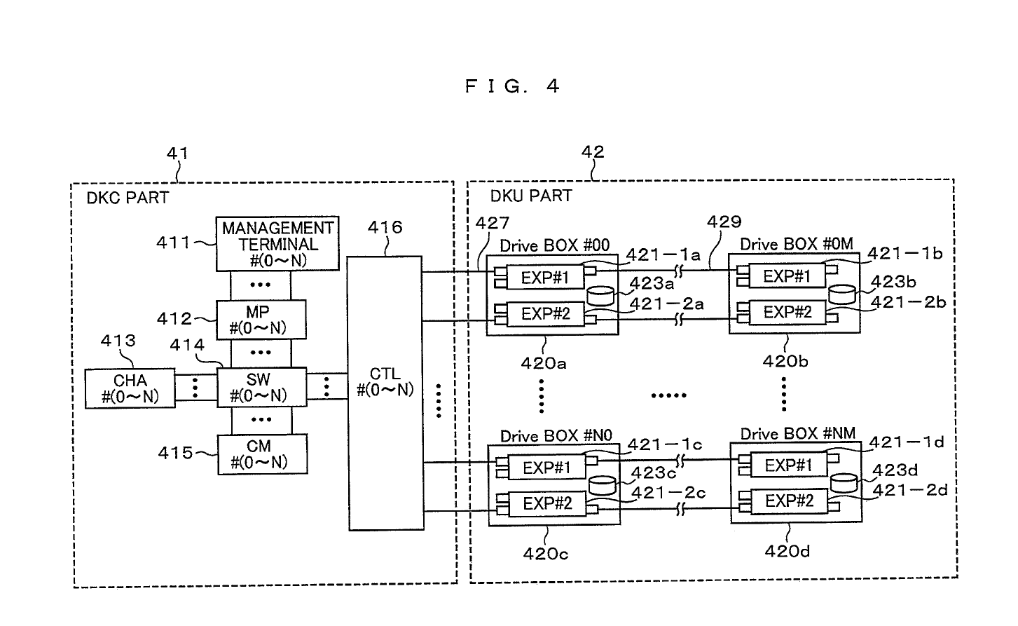

The configuration of the disk array system for implementing the present invention is shown in FIG. 4.

The disk array system includes a DKC (Disk Controller) part 41 for receiving a writing/reading request from a host computer (not shown) to a disk and exchanging data between the host computer and the disk, and a DKU (Disk Unit) part 42 having a plurality of disks. The present invention can be applied not only to the disk shown in FIG. 4 but also to a memory device such as a SSD (Solid State Drive).

The DKC part 41 includes: a CHA (Channel Adopter) 413 for controlling the interface with the host computer; a plurality of CMs (Cache Memories) 415 for temporarily storing data written to the disk or data read from the disk, as well as various control information for controlling the disk array system, and the like; a plurality of MPs (Micro Processors) 412 for controlling the transmission and reception of requests and data between the host computer and each of the disks; a plurality of CTLs (Controller Boards) 416 for controlling the transmission and reception of requests and data with a plurality of drive boxes 420 each including at least one disk; a SW (Switch) 414 for connecting MP 412, CHA 413, CM 415, and CTL 416 to each other; and a plurality of management terminals 411 by which the user manages the operations of the individual MPs 412. It is redundant according to the multiplicity of the process. An input device, such as a keyboard and a mouse, as well as a management terminal device having a display are provided outside the DKC part 41. A management terminal 411 shown in FIG. 4 provides control of the management terminal device and the interface.

In the DKU part 42, a plurality of drive boxes 420 each including at least one auxiliary memory device (disk) are connected in a daisy chain fashion. One drive box 420 includes two EXPs 421, which correspond to two access paths to a plurality of auxiliary memory devices (disks) 423. FIG. 4 shows the case of using two paths. However, the present embodiment can also be applied to the case of using only one path. Both EXP #1 and EXP #2 in one drive box can access the same auxiliary memory device (disk) 423. Note that the CTL to EXP connection and the EXP to EXP connection between two different drive boxes are cable connection by CC (Copper Cable, electrical signal cable) or by AOC (Active Optional Cable, optical signal cable).

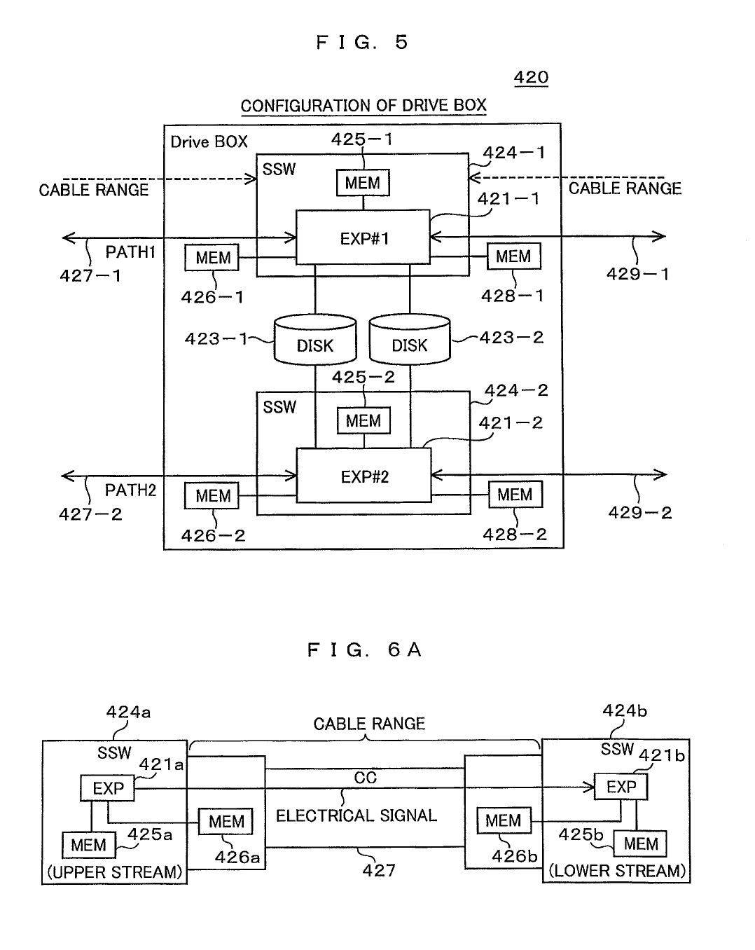

FIG. 5 shows the internal configuration of the drive box 420. The drive box 420 has two SSWs (SAS-Switches) 424 corresponding to two paths. Both the two SSWs 424 access the same auxiliary memory device (disk) 423. In FIG. 5, the left side of the SSW 424 is defined as the upper stream and the right side is defined as the lower stream.

An upstream cable 427 and a downstream cable 429 are connected to the SSW 424. Each of the transmission and reception terminals (connectors) of the cable includes MEMs (memories) 426 and 428. The SSW 424 has the EXP 421, and a MEM (Memory) 425 which is used for control and connected to the EXP 421. Note that when the cable is AOC, as shown in FIG. 2, each of the transmission and reception terminals (connectors) of the cable includes an EOC (Electrical Optical Converter) for converting the electrical signal on the transmission path to an optical signal, or converting the optical signal to an electrical signal. However, the EOC is not shown in FIG. 5.

In the disk array system shown in FIG. 4, M+1 auxiliary memory devices (disks) 423 are daisy-chained by the drive boxes #k0 to #kM (k=0 to N) 420. In this way, one CTL-EXP path is formed. In the DKU part 42, N+1 CTL-EXP paths are present according to the multiplicity (N+1) of the process in the DKC part 41. Here, the length of the chain is represented by M, which has nothing to do with the multiplicity (N+1). Further, the length of the chain (M) may be different depending on the CTL-EXP path.

Each drive box 420 is assigned an address including a number for identifying the CTL-EXP path as well as a number sequentially assigned from the upper stream to the lower stream, with the disk access path of a plurality of disks connected in a daisy chain fashion. Thus, the MP 412 or the CTL 416 issues a request including this address to each drive box 420 to acquire specific information. Further, each drive box 420 transmits the particular address and the specific information to the MP 412 or the CTL 416. In this way, the MP 412 or the CTL 416 can identify the source of the received information.

### (Outline of Cable Connection Configuration)

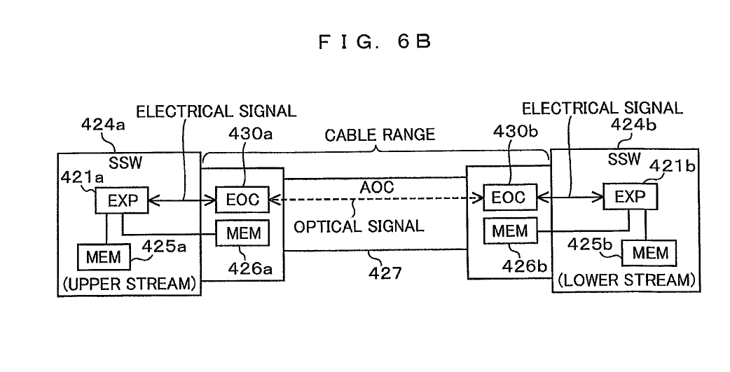

In the range of the storage interface to be used, the cable connection is required in the range of CTL-EXP and the range of EXP-EXP. FIG. 6A is a view of the connection between EXP and EXP by using CC, and FIG. 6B is a view of the connection between EXP and EXP by using AOC. In FIG. 6, different from FIG. 5, the left and right sides of the cable 427 are distinct such that the left side is defined as the upper stream (U) and the right side is defined as the lower stream (L). The two types of MEMs are denoted by distinct symbols, the MEM (EX-MEM) 425 included in the SSW 424 and the MEM (CB-MEM) 426 included in the cable 427. Further, it is assumed that the CTL 416 is connected on the upstream side.

An EXP 421a close to the CTL 416 is defined as an upstream EXP (U-EXP), and an EXP 421b connected through the cable 427 is defined as a downstream EXP (L-EXP). The connection between CTL and EXP is made by only replacing the upstream EXP (U-EXP) of the connection between EXP and EXP, with the CTL 416. Thus, there is no change in the cable connection configuration. The EXP (U-EXP) 421a and the CTL 416 acquire the CABLE information by accessing the MEM (U-CB-MEM) 426a on the upstream side of the connected cable 427.

In the following, the transmission path is referred to as “cable” and the name of the information is referred to as “CABLE information”.

The EXP or the CTL acquires the CABLE information from the upstream MEM (U-CB-MEM) 426a of the cable 427, and sets the acquired information to the MEM (U-EX-MEM) 425a of the upstream EXP and to the MEM (L-EX-MEM) 425b of the downstream EXP, respectively. It is also possible that the same process is performed on the upstream side, while on the downstream side, the upstream EXP transmits an information acquisition request to the downstream EXP, acquires the CABLE information from the MEM (L-CB-MEM) 426b on the downstream side of the cable 427, and sets the acquired CABLE information to the MEM (L-EX-MEM) 425b of the downstream EXP.

The CABLE information including the cable type and the setting information (protocols and parameters) are stored in advance in the built-in MEM (Memory, for example, flash memory or ROM) included in each of the transmission and reception terminals (connectors) on the upstream and downstream sides of the cable 427.

When the cable 427 is CC, the electrical signal is directly transmitted to the cable 427. When the cable 427 is AOC, the electrical signal from the transmission side EXP 421a is converted to an optical signal by the EOC 430a. Then, the optical signal is transmitted to the cable 427. On the reception side, the optical signal is converted to an electrical signal by the EOC 430b. Then the converted electrical signal is input to the EXP 421b.

### (Outline of CABLE Information Acquisition and Setting Process)

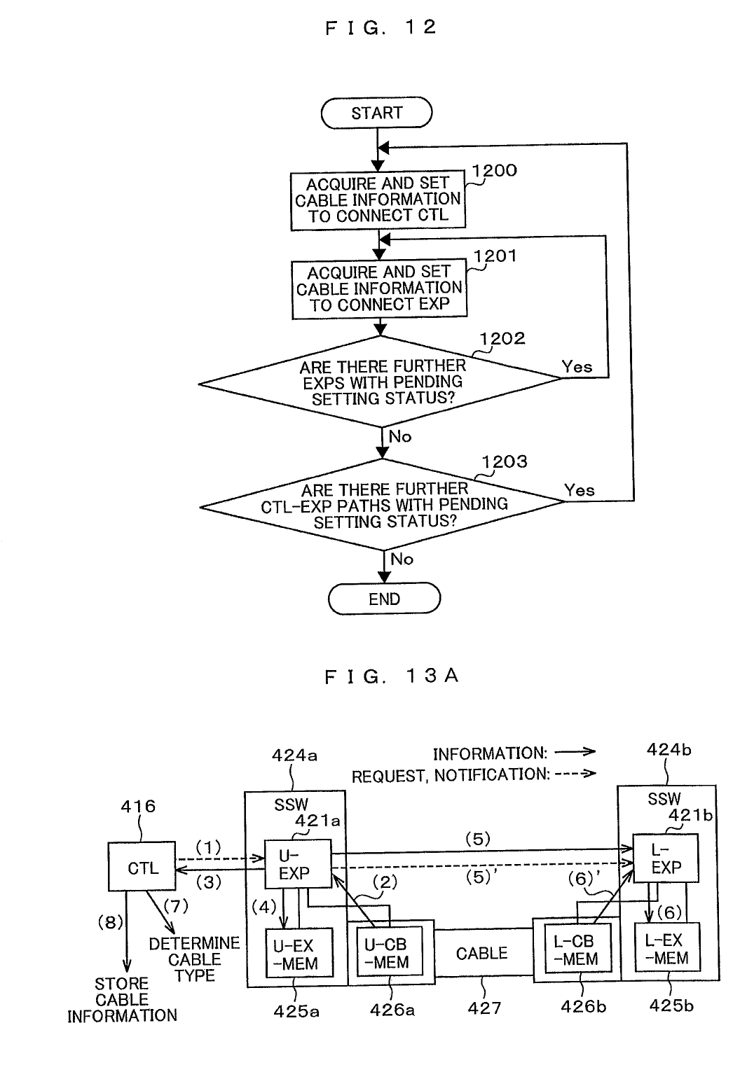

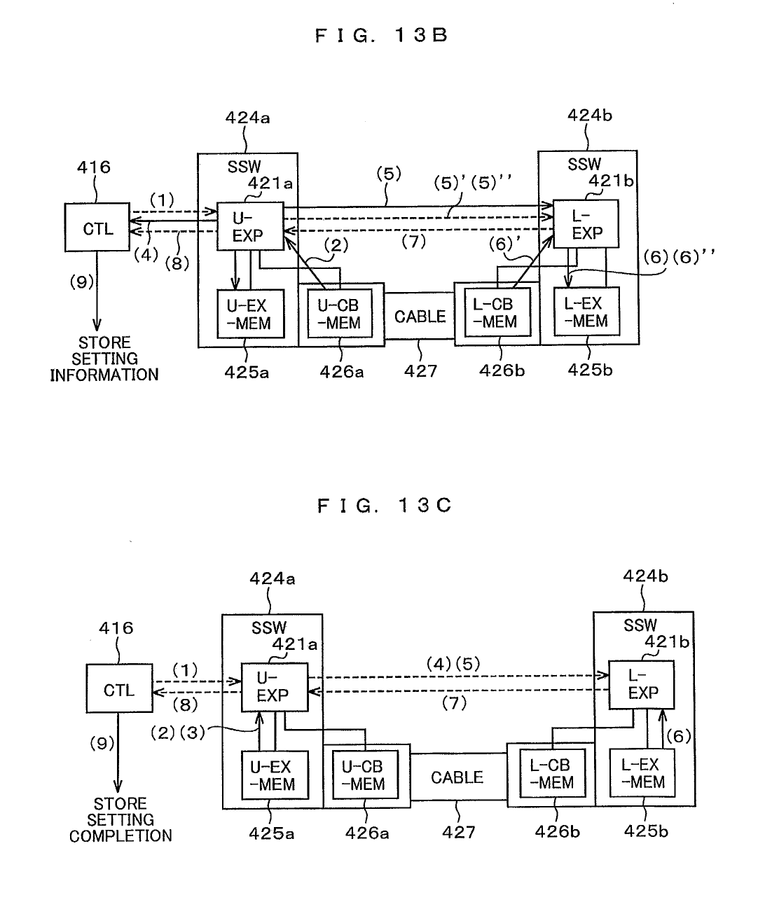

Exchange of information, as well as transmission and reception of request and notification messages will be described with reference to FIG. 13, in a series of processes involved in cable type identification (FIG. 13A), setting information acquisition (FIG. 13B), and setting information setting (FIG. 13C). The numbers in parentheses shown in FIGS. 13A to 13C correspond to the numbers of the process steps described below in the figures.

The CABLE information includes the cable type and the setting information (the proper protocol and parameters). In the following process procedure, it is assumed that these pieces of information are acquired by separate procedures.

Before the acquisition and setting of the CABLE information, the disk array system sets the connection to the settings (for example, the AOC protocol setting, and the setting of the signal rate lower than the rate of normal operation) to be able to transmit signals, without performing the optimal protocol setting and parameter setting.

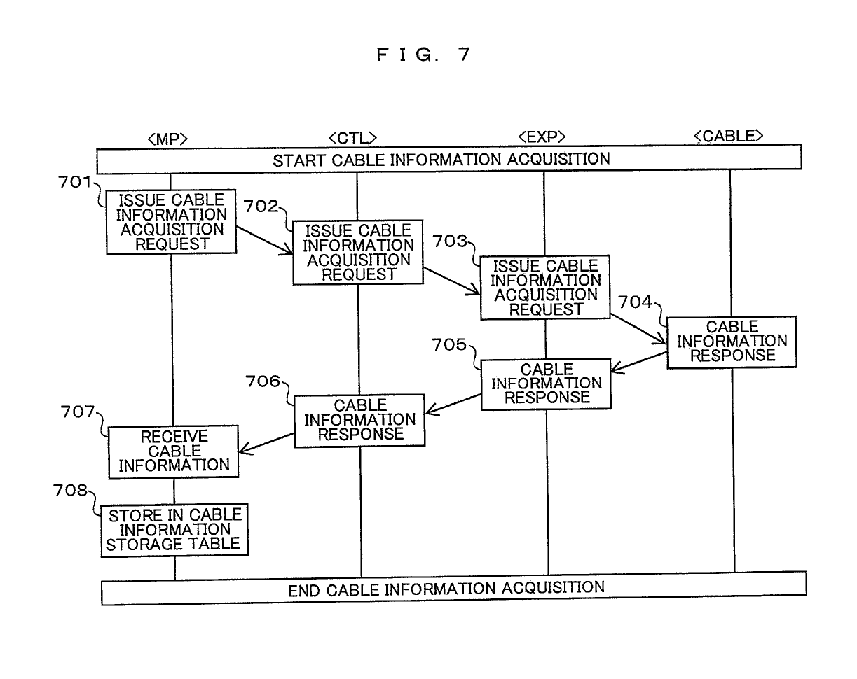

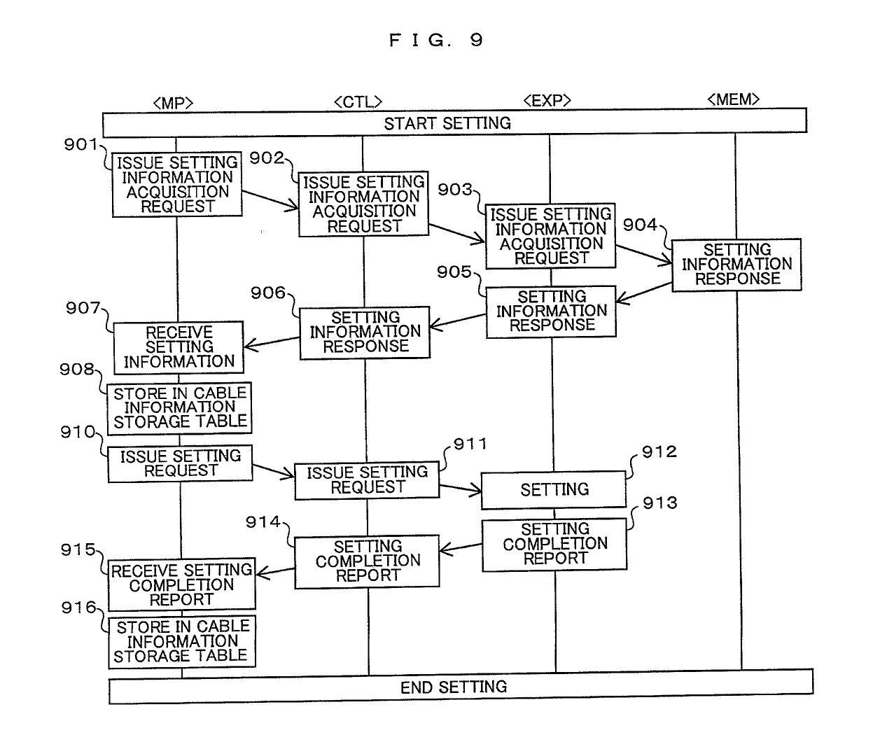

(A) The process of identifying the cable type will be described with reference to FIG. 13A (corresponding to FIG. 7).
(1) The upstream EXP (U-EXP) 421a receives a CABLE information acquisition request from the CTL 416 (or the MP 412).
(2) The upstream EXP (U-EXP) 421a reads the cable type included in the CABLE information stored in the MEM (U-CB-MEM) 426a on the upstream side of the cable.
(3) The upstream EXP (U-EXP) 421a transmits the read cable type to the CTL 416.
(4) The upstream EXP (U-EXP) 421a stores the cable type included in the CABLE information in the MEM (U-EX-MEM) 425a of the upstream EXP.
(5) The upstream EXP (U-EXP) 421a also transmits the cable type included in the CABLE information to the downstream EXP (L-EXP) 421b.
(6) The downstream EXP (L-EXP) 421b stores the cable type included in the CABLE information received from the upstream EXP (U-EXP) 421a, in the MEM (L-EX-MEM) 425b of the downstream EXP.
(The above (5)-(6) can be replaced by the following alternative procedure of (5)′-(6)′ using the information stored in the MEM (L-CB-MEM) 426b on the downstream side of the cable.)
(5)′ The downstream EXP (L-EXP) 421b receives the CABLE information acquisition request from the upstream EXP (U-EXP) 421a.
(6)′ The downstream EXP (L-EXP) 421b reads the cable type included in the CABLE information that is stored in the MEM (L-CB-MEM) 426b on the downstream side of the cable, and stores the read cable type in the MEM (L-EX-MEM) 425b of the downstream EXP.
(7) The CTL 416 stores the cable type included in the CABLE information received from the upstream EXP (U-EXP) 421a.
(8) The CTL 416 identifies the type of the cable (CC or AOC) based on the address showing the cable type included in the CABLE information.
(B) The setting information acquisition process will be described with reference to FIG. 13B (corresponding to the first half of FIG. 9).
(1) The upstream EXP (U-EXP) 421a receives the request to acquire the setting information (the proper protocol and parameters) corresponding to the cable type, from the CTL 416.
(2) The upstream EXP (U-EXP) 421a reads the setting information included in the CABLE information stored in the MEM (U-CB-MEM) 426a on the upstream side of the cable.
(3) The upstream EXP (U-EXP) 421a stores the setting information included in the CABLE information in the MEM (U-EX-MEM) 425a of the upstream EXP.
(4) The upstream EXP (U-EXP) 421a transmits the setting information included in the CABLE information to the CTL 416.
(5) The upstream EXP (U-EXP) 421a transmits the setting information included in the CABLE information to the downstream EXP (L-EXP) 421b.
(6) The downstream EXP (L-EXP) 421b stores the setting information included in the CABLE information received from the upstream EXP (U-EXP) 421a, in the MEM (L-EX-MEM) 425b of the downstream EXP.
(The above (5)-(6) can be replaced by the following alternative procedure of (5)′-(5)″-(6)′-(6)″ using the information stored in the MEM (L-CB-MEM) 426b on the downstream side of the cable.)
(5)′ The upstream EXP (U-EXP) 421a transmits a setting information acquisition request to the downstream EXP (L-EXP) 421b.
(5)″ The downstream EXP (L-EXP) 421b receives the setting information acquisition request from the upstream EXP (U-EXP) 421a.
(6)′ The downstream EXP (L-EXP) 421b reads the setting information included in the CABLE information stored in the MEM (L-CB-MEM) 426b on the downstream side of the cable.
(6)″ The downstream EXP (L-EXP) 421b stores the setting information include in the CABLE information, in the MEM (L-EX-MEM) 425b of the downstream EXP.
(7) The downstream EXP (L-EXP) 421b notifies the upstream EXP (U-EXP) 421a that the setting information acquisition has been completed.
(8) In response to the notification of the completion of the setting information acquisition from the downstream EXP (L-EXP) 421b, the upstream EXP (U-EXP) 421a reports to the CTL 416 that the setting information acquisition has been completed by the EXP 421 on the upstream and downstream sides.
(9) In response to the notification of the completion of the setting information acquisition by the upstream and downstream EXPs 421 from the upstream EXP (U-EXP) 421a, the CTL 416 stores the received setting information.
(C) The process of setting the setting information will be described with reference to FIG. 13C (corresponding to the last half of FIG. 9).
(1) The upstream EXP (U-EXP) 421a receives a request from the CTL 416 to set the setting information corresponding to the cable type.
(2) The upstream EXP (U-EXP) 421a reads the setting information from the CABLE information stored in the MEM (U-EX-MEM) 425a of the upstream EXP.
(3) The upstream EXP (U-EXP) 421a sets the setting information to the upstream EXP (itself) (U-EXP) 421a.
(4) The upstream EXP (U-EXP) 421a transmits the setting information setting request to the downstream EXP (L-EXP) 421b.
(5) The downstream EXP (L-EXP) 421b receives the setting information setting request from the upstream EXP (U-EXP) 421a.
(6) The downstream EXP (L-EXP) 421b sets the setting information stored in the MEM (L-EX-MEM) 425b of the downstream EXP, in the downstream EXP (itself) (L-EXP) 421b.
(7) The downstream EXP (L-EXP) 421b notifies the upstream EXP (U-EXP) 421a of the completion of the setting information setting.
(8) In response to the notification of the completion of the setting information setting from the downstream EXP (L-EXP) 421b, the upstream EXP (U-EXP) 421a reports to the CTL 416 that the setting information setting has been completed by the EXP 421 on the upstream and downstream sides.
(9) In response to the notification of the completion of the setting information setting by the upstream and downstream EXPs 421 from the upstream EXP (U-EXP) 421a, the CTL 416 stores the received setting completion report.

After the completion of the acquisition and setting of the CABLE information, the disk array system sets the connection to a high transmission rate for normal operation.

In the above exemplary embodiment, the CABLE information is stored in the MEM (U-CB-MEM) on the upstream side of the cable and in the MEM (L-CB-MEM) on the downstream side of the cable. However, if the amount of data is large, not all the setting information may be stored in the MEM (U-CB-MEM) 426 included in the cable 427. In this case, only the information of the type of the cable is stored in the CABLE information, and the setting information (the protocol and parameters) corresponding to the type is stored in the MP 412 or the CTL 416. In this way, the MP 412 or the CTL 416 can identify the type of the cable to set the setting information corresponding to the identified cable type, to the EXP 421.

In FIG. 13, there is described the exchange of information, as well as the transmission and reception of request and notification messages, in a series of processes involved in the cable type identification, the setting information acquisition, and the setting information setting. In the following, a description will be given of the process flow shown in FIG. 13 that is performed in the individual components in the configuration of the disk array system shown in FIG. 4. In FIG. 13, the CABLE information acquisition request and the setting information setting request are issued by the CTL 416. However, in the following description, it is assumed that these requests are issued by the MP 412 and transmitted to the EXP 421 through the CTL 416. Although the source of the requests (namely, the subject of the CABLE information settings) is different from the case of FIG. 13, a series of processes involved in the cable type identification, the setting information acquisition, and the setting information setting are the same.

### (Cable Type Identification)

FIG. 7 is the information acquisition flow of the cable 427 to be connected to the EXP 421. FIG. 7 shows the process performed by the MP 412, the CTL 416, the EXP 421, and the cable 427, respectively, in chronological order.

The upstream EXP (U-EXP) 421a receives the CABLE information acquisition request from the MP 412 through the CTL 416. Then, the upstream EXP (U-EXP) 421a accesses the MEM (U-CB-MEM) 426a on the upstream side of the cable within the CABLE by using an I2C (Inter-Integrated Circuit) bus (701 to 703), and acquires the CABLE information (704).

The CABLE information is transmitted to the MP 412 through the EXP 421 and the CTL 416 (705 to 707). Then, the MP 412 stores the CABLE information in a CABLE information storage table (708). Then, the MP 412 identifies the type of the particular cable based on the information of cable type included in the CABLE information.

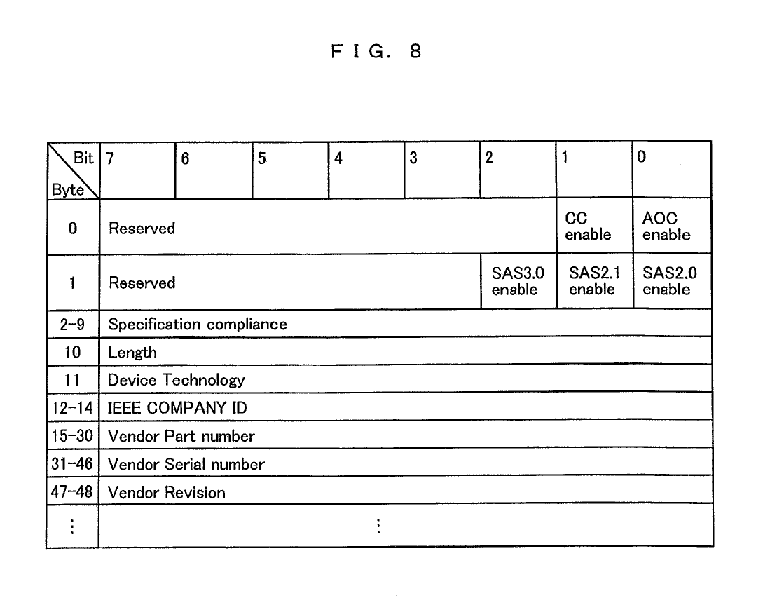

An example of the CABLE information is shown in FIG. 8. As shown in FIG. 8, the CABLE information includes a plurality of byte data, in which Byte 0 and Byte 1 are fixed areas in which the cable type is stored, and other related information are stored in Byte 2 and subsequent areas. For example, the MEM 426 of QSFP+cable or mini SAS HD cable has an address for storing the information that can identify the type of the cable according to the standard. Thus, it is possible to determine the type of the cable (CC or AOC, as well as the SAS standard), by using the information stored in the address, or by storing in advance the determination information in a specific address (for example, Byte 0-Bit 0, 1 and Byte 1-Bit 0-2) and using the information stored in the particular address. Further, it is also possible to determine the type of the cable by storing in advance the CABLE information in the user area of the cable upstream MEM (C-U-MEM) 426a within the CABLE, and acquiring the particular CABLE information.

### (Setting Information Acquisition)

FIG. 9 is a flow of setting the proper protocol and parameters to the upstream EXP 420 based on the CABLE information. FIG. 9 shows the setting information acquisition process (901 to 908) as well as the setting information setting process (910 to 916), which are performed by the MP 412, the CTL 416, the EXP 421, and the MEM 426 on the upstream side (and downstream side) of the cable, respectively, in chronological order.

The upstream EXP (U-EXP) 421 receives the setting information acquisition request from the MP 412 through the CTL 416. Then, the upstream EXP (U-EXP) 421 accesses the MEM (U-CB-MEM) 426a on the upstream side of the cable within the CABLE by using the I2C (Inter-Integrated Circuit) bus (901 to 903). Then, the upstream EXP (U-EXP) 421 acquires the setting information included in the CABLE information (904).

The setting information is transmitted to the MP 412 through the EXP 421 and the CTL 416 (905 to 907). The MP 412 stores the setting information in the CABLE information storage table (908).

In Step 905, the protocol setting information and parameter setting information, which are appropriate for the cable type included in the CABLE information, are acquired from the MEM (U-EX-MEM) 425a of the upstream EXP on the upstream SSW 424. Further, it is also possible to store the setting information in the user area of the MEM (U-CB-MEM) 426a on the upstream side of the cable within the CABLE in advance, and to access the MEM 426 within the CABLE to acquire the setting information.

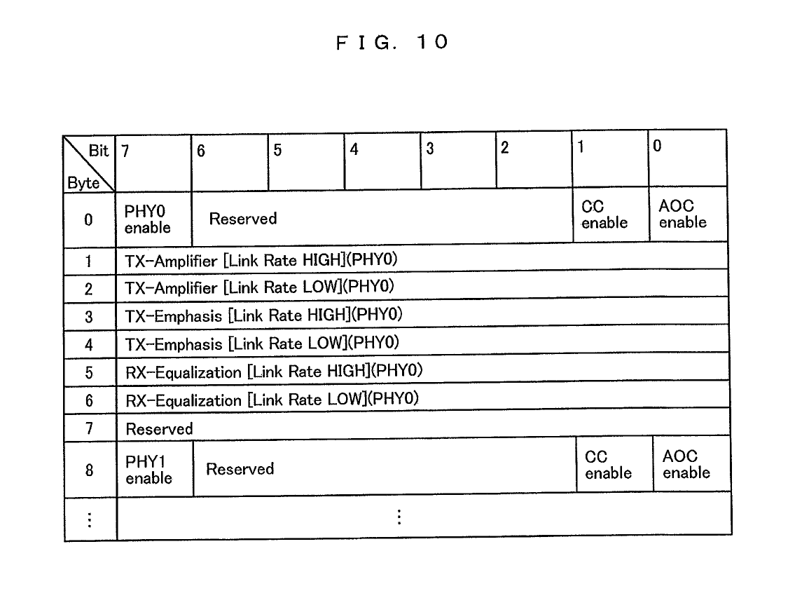

An example of the setting information is shown in FIG. 10. As shown in FIG. 10, the setting information includes a plurality of byte data, in which the information on the protocol according to the cable type is stored in Byte 0, and various parameters relating to the cable type are stored in Byte 1 and subsequent areas. It is designed to make it possible to set, for example, the AOC protocol setting enable bit (Byte 0-Bit 0), the transmission signal amplitude value (Tx-Amplifier) (Byte 1, 2), the emphasis (Tx-Emphasis) (Byte 3, 4), and the reception-side equalization correction setting (Rx-Equalization) (Byte 5, 6), and the like, for each PHY (part of the device serving as the interface between devices).

The acquired CABLE information and setting information, as well as the setting completion information described below, are stored in the CABLE information storage table within the MP 412 (or the CTL 416), which is shown in FIG. 11. The CABLE information storage table shown in FIG. 11 includes: CABLE connection position 111 that stores the identifiers of the CTL 416 or EXP 421 to which each cable is connected, in the order from the upstream side to the downstream side, for one CTL 416 and for each CTL-EXP path 110 including one or a plurality of EXPs 420 daisy-chained to the particular CTL; CABLE information 112 that stores the types of cables connected to the downstream side of the CTL 416 or EXP 421 to be identified by the CABLE connection position 111; setting information (protocol) type 113 corresponding to the cable type; setting information type (parameter) 114; and setting information status 115.

Note that, when each of the CTL-EXP paths includes two paths as shown in FIG. 4, the CTL-EXP path 110 is divided into, for example, “0-1” and “0-2”, and so on as shown in FIG. 11. Then, the items 111 to 115 are provided for each path. In addition, the EXP 421 of the CABLE connection position 111 is also denoted for each path, for example, by “EXP-00#1” and “EXP-00#2” (however, the CTL is common to all the paths).

The M-th EXP 421, which is the last stage of one CTL-EXP path, for example, EXP-0(M) 421-1b shown in FIG. 4, is not able to be provided on the upstream side of the cable and does not acquire further information from the lower (downstream) stage, so that it is not shown in the table.

### (Setting Information Setting)

In FIG. 9, upon receiving the setting information setting request from the MP 412 through the CTL 416, the upstream EXP (U-EXP) 421a accesses the MEM (U-CB-MEM) 426a on the upstream side of the cable within the CABLE by using the I2C (Inter-Integrated Circuit) bus, and sets the setting information included in the CABLE information to the upstream EXP (U-EXP) 421a (itself) (910 to 912). Then, the upstream EXP (U-EXP) 421a notifies the MP 412 of the completion of the setting of the setting information through the CTL 416 (913 to 915). The MP 412 stores the completion of the setting of the setting information in the CABLE information storage table (916). In Step 912, the upstream EXP (U-EXP) 421a shown in FIG. 6 transmits the setting information setting request or similar setting information also to the downstream EXP (L-EXP) 421b.

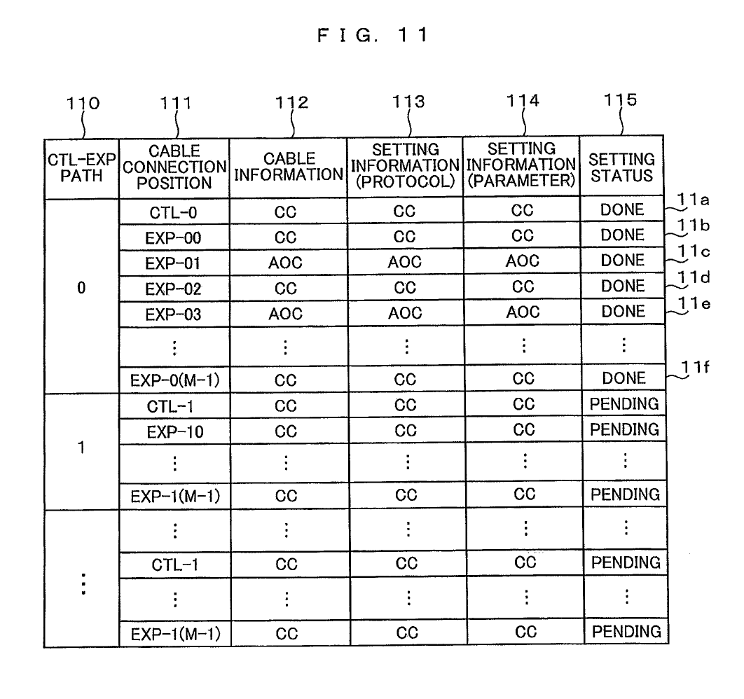

In the disk array system, there are a plurality of CTLs 416. Thus, the disk array system acquires and sets the CABLE information for one CTL-EXP path based on the CABLE information storage table shown in FIG. 11. Then, the disk array system acquires and sets the CABLE information of uncompleted CTL-EXP paths. This series of processes is shown in FIG. 12.

The disk array system acquires and sets the CABLE information to be connected to the CTL 416 for one CTL-EXP path based on the CABLE information storage table shown in FIG. 11 (1200). Then, the disk array system acquires and sets the CABLE information to be connected to the EXP 421 included in the particular CTL-EXP path based on the CABLE information storage table shown in FIG. 11 (1201). Then, the disk array system determines if there are further EXPs 421 with the setting uncompleted. When there is no EXP 421 with the setting uncompleted, the disk array system performs the next step 1203, and if there is the EXP 421 with the setting uncompleted, the disk array system returns to Step 1201. The disk array system determines if there are further CTL-EXP paths with the setting status 115 being uncompleted in the CABLE information storage table shown in FIG. 11. When there is no CTL-EXP path with the setting uncompleted, the disk array system ends the process. If there is the CTL-EXP path with the setting uncompleted, the disk array system returns to Step 1200.

After the setting status completion has been confirmed, the CC connection part and the AOC connection part are operated with the appropriate settings.

Note that in the setting information setting, the protocol setting specifies the protocol corresponding to the data transmission method, in particular, the idle method, and the parameter setting includes the proper value of the signal amplitude, the emphasis, or other settings.

According to the first embodiment, even if CC and AOC are mixed in the transmission path of the disk array system, it is possible to set the appropriate parameters for the CC and the AOC to the EXP.

Further, the present invention is not limited to the SAS standards and cable types shown in FIG. 1, and can also be applied to other standards and cables, such as PCI-express.

### Second Embodiment

In the second embodiment, a description will be given of an example of limiting the target part of the cable type determination operation, in view of the configuration of the disk connection in the disk array system. According to the present embodiment, it is possible to reduce the process time associated with the determination operation by limiting the target part of the cable type determination operation. The second embodiment can be combined with the first embodiment.

In the DKU part 42 of the disk array system, a plurality of EXPs 421 are connected as shown in FIG. 4. It takes time to set the CABLE information for all the EXPs 421, so that the MP 412 or the CTL 416 performs the cable determination and the setting operation in advance, with respect to the EXP 421 capable of connecting AOC.

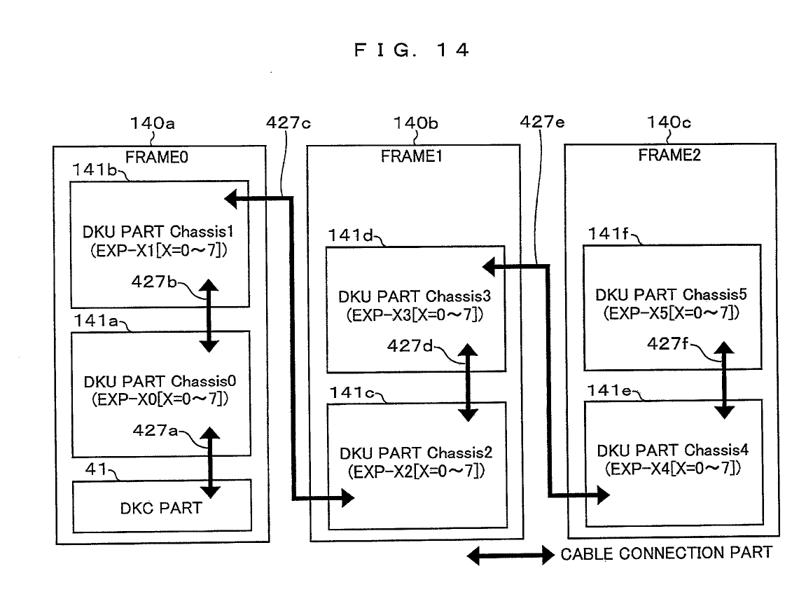

For example, as shown in FIG. 14, the CTL-EXP path is 8 (the multiplicity N=7) and 8 drive boxes including EXP-XN [X=0 to 7] are collectively referred to as chassis 141, in which two chassis are mounted in one frame 140. In this case, there are six parts of the cable connection between the DKC part 41 and the DKU part 42 in one CTL-EXP system. Of the six parts of the cable connection, based on the CABLE information storage table shown in FIG. 11, the part that is likely to use AOC is limited to two parts, namely, the part between EXP-X1 and EXP-X2 (427c) and the part between EXP-E3 and EXP-X4 (427e) in which the frame connection with a long cable length occurs. With respect to the cable connections within other frames (427a, 427b, 427d, 427f), the cable length is short, so that the connections parts are connected by CC. The EXP 421 for acquiring the CABLE information is limited to EXP-E1 and EXP-X3 to which AOC is connected, so that it is possible to reduce the operation of the cable determination and setting. In this way, the CABLE information acquisition necessity determination table is generated based on the CABLE information storage table shown in FIG. 11, and on the frame connection shown in FIG. 14. An example of the CABLE information acquisition necessity determination table is shown in FIG. 15.

The CABLE information acquisition necessity determination table shown in FIG. 15 is a table generated by adding the item of information acquisition necessity 150 to the CABLE information storage table shown in FIG. 11. In FIG. 15, the information acquisition necessity is defined as “YES” for EXP-01 within the drive box 420a to which AOC 427c is connected and for EXP-03 within the drive box 420b to which AOC 427e is connected as shown in FIG. 14.

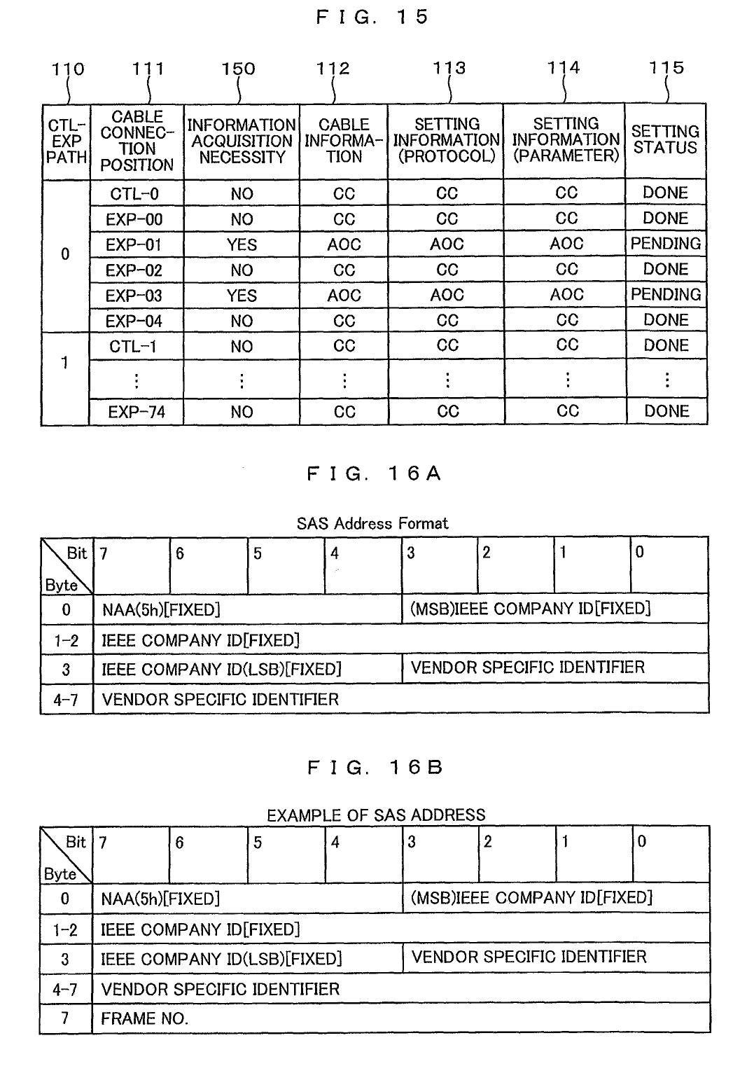

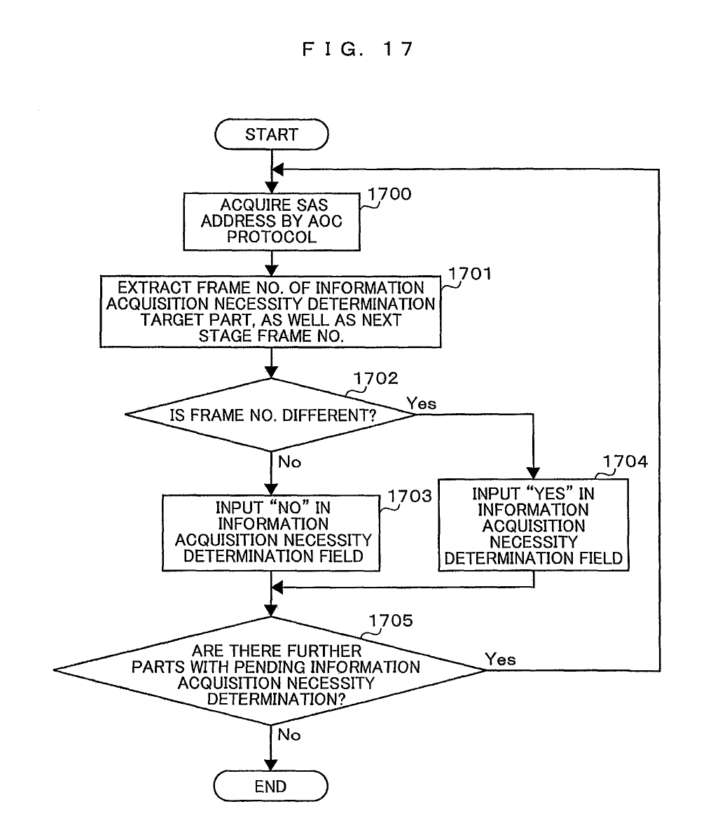

As an example of the method of determining the information acquisition necessity in FIG. 15, the use of SAS address will be described. First, the format of the SAS address is shown in FIG. 16A. Further, FIG. 16B shows an example of the SAS address for identifying the connection part between the frames. The SAS address has the vender specific area (Byte 4-7), so that the position information such as the frame number is stored in this area in advance. The EXP 421 for frame connection can be identified from the SAS address. As a result, it is possible to determine whether the information acquisition is necessary or not.

Next, the flow of the information acquisition necessity determination from the SAS address is shown in FIG. 17.

The disk array system issues a CABLE information acquisition request to the EXP 421 within the drive box 420a provided in each frame 140 by the AOC protocol, and acquires the SAS address shown in FIG. 16 (1700). Then, the disk array system extracts the frame number of the information acquisition necessity determination target part, as well as the frame number of the next stage (1701). Then, the disk array system determines whether the two frame numbers are different (1702). If the two frame numbers are the same, the disk array system inputs “NO” in the information acquisition necessity 150 of the CABLE information acquisition necessity determination table shown in FIG. 15 (1703). If the two frame numbers are different, the disk array system inputs “YES” in the information acquisition necessity 150 of the CABLE information acquisition necessity determination table shown in FIG. 15 (1704). Then, the disk array system determines whether there are further pending parts in the information acquisition necessity 150 (1705). If there is the pending part in the information acquisition necessity 150, the disk array system returns to Step 1700. If there is no pending part, the disk array system ends the process.

In order to acquire all the SAS addresses, it is necessary to access the EXPs 421 from the first to the last stages. Thus, when the SAS addresses are acquired, the disk array system sets all the cable-to-cable connections to the settings (for example, the AOC protocol setting, and the setting of the signal rate lower than the rate of normal operation) to be able to transmit signals, without performing the optimal protocol setting and parameter setting.

In general, AOC does not allow DC (direct current) transmission while CC allows DC transmission. On the other hand, the low rate AOC protocol can be applied not only to AOC but also to CC, but the low rate CC protocol may not be applied to AOC for the reasons described above. Thus, like the SAS address acquisition, when it is unknown whether the cable is CC or AOC and when the transmission process can be performed with a low rate, the AOC protocol is used to be able to perform the transmission process regardless of whether the cable is CC or AOC.

The AOC protocol is different from the CC protocol in that the part (D.C. Idle) of the DC (Direct Current) component used in the initialization sequence is replaced by a specific signal pattern. The CC connection can be used when both transmission and reception LSIs are set to the AOC protocol with the transmission characteristics that can transmit the signal pattern of the AOC protocol.

When the information acquisition necessity is determined, the part requiring no information acquisition uses the CC connection, so that the setting is returned to the CC setting. Then, the disk array system acquires the information for the part requiring the information acquisition and makes the appropriate settings.

### Third Embodiment

In the third embodiment, a description will be given of an example of automatic switching when the CABLE information has not been acquired. According to the present embodiment, it is possible to make the appropriate setting for the cable without acquiring the CABLE information.

It will show an example of performing the appropriate setting when the CABLE information has not been acquired. The expected value of the number of connected stages of the EXP 421 of the DKU part 42 is stored on the disk array system in advance. The “expected value” is a value that is determined by the number of drive boxes 420 managed by the disk array system.

After power on the disk array system, the MP 412 or the CTL 416 performs the initialization sequence by the CC protocol and parameters.

In the initialization sequence, the number of connected stages of the EXP 421 can be found, as shown in FIG. 7, by issuing a CABLE information acquisition request to each driver box 420 to determine the presence of the response (CABLE information) from each driver box 420. It is also possible to know the number of connected stages of the EXP 421, as the initialization sequence, by issuing a command to each drive box 420 to check the connection status.

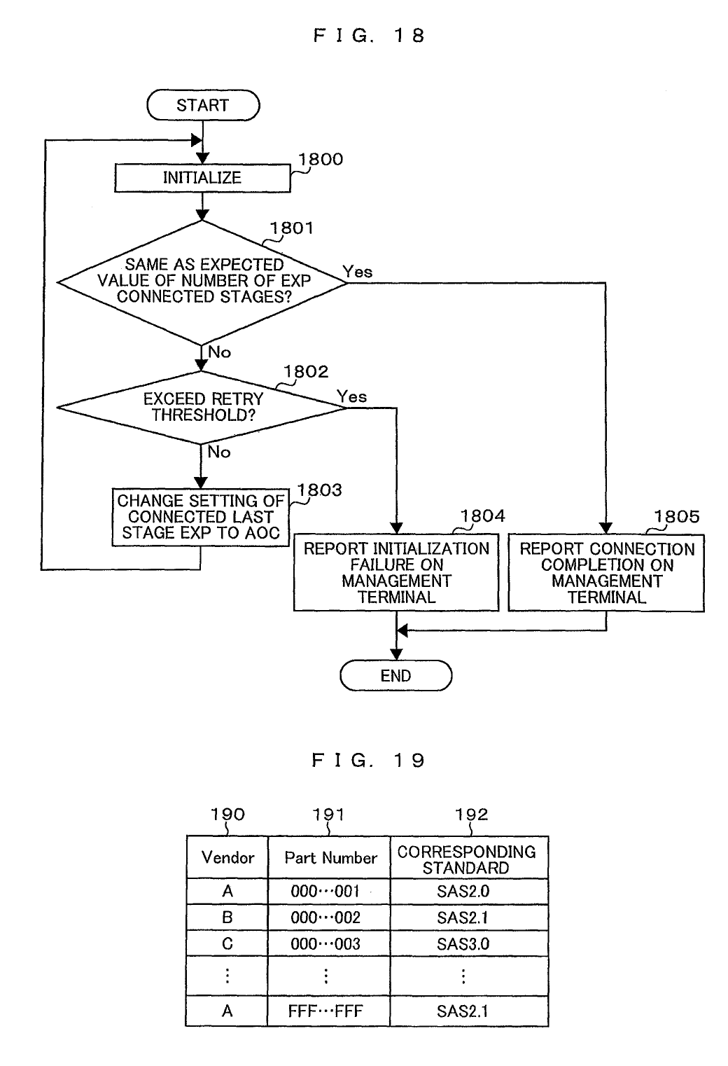

When it is determined that the number of connected stages of the EXP 421 is different from the expected value, it is assumed that AOC is connected to the EXP 421 of the last stage that can be accessed. The MP 412 or the CTL 416 changes the setting of the part ranging from the EXP 421 of the last accessible stage to the subsequent stage into the AOC protocol and parameters, and performs again the initialization sequence. The same process is repeated several times until the number of connected stages of the EXP 421 is equal to the expected value of the number of connected stages of the EXP 421. The MP 412 or the CTL 416 determines the threshold by the number of retries of the initialization sequence or by the retry time. If the value exceeds the threshold, the MP 412 or the CTL 416 notifies that the initialization sequence is not done, on the management terminal. This flow is shown in FIG. 18.

The MP 412 or the CTL 416 performs the initialization sequence of the SAS address acquisition shown in FIG. 16 (1800). Then, disk array system determines whether the actual value of the number of EXP connected stages is equal to the expected value (1801). When the two values are the same, the MP 412 or the CTL 416 reports the connection completion to the management terminal 411 (1805), and ends the process. If the two values are different, the MP 412 or the CTL 416 determines whether the number of retries of the initialization sequence exceeds the retry threshold (1802). If the number of retries exceeds the retry threshold, the MP 412 or the CTL 416 reports the failure of the initialization to the management terminal 411 (1804), and ends the process. If the number of retries does not exceeds the retry threshold, the MP 412 or the CTL 416 changes the setting of the connected EXP of the last stage to AOC (1803), and returns to Step 1800.

### Fourth Embodiment

In the fourth embodiment, a description will be given of an example of using the method of limiting the target part of the cable determination operation according to the second embodiment, as well as the automatic switching when the CABLE information has not been acquired according to the third embodiment.

After the information acquisition necessity is determined by the method of the second embodiment, the disk array system makes the CC setting or the AOC setting by the automatic switching of the third embodiment, instead of performing the CABLE information acquisition with respect to the part requiring the information acquisition. The connection status between the frames can be checked by the method described in the third embodiment.

According to the fourth embodiment, it is possible to reduce the time for the cable determination operation and to automate the process for the part requiring information acquisition.

### Fifth Embodiment

In the fifth embodiment, an operation example of the SAS 2.0 based CTL/EXP and the SAS 2.0 compliant AOC will be described. According to the present embodiment, it is possible to set the appropriate setting information according to the cable type based on the product part number of the cable that the user knows.

The SAS 2.0 based CTL/EXP has no AOC protocol setting. Thus, when a general AOC is connected, a protocol violation occurs. When the SAS 2.0 compliant AOC is used, the SAS 2.0 based CTL/EXP can be connected by AOC. The information of which standard corresponds to the particular AOC according to the vender and the part number, is stored in the MP 412 or the CTL 415, as a table of the correspondence between the AOC products and the standards as shown in FIG. 19.

FIG. 19 is a table showing to which standard 192 a vender 190 and a part number 191 of an AOC provided by the vender correspond.

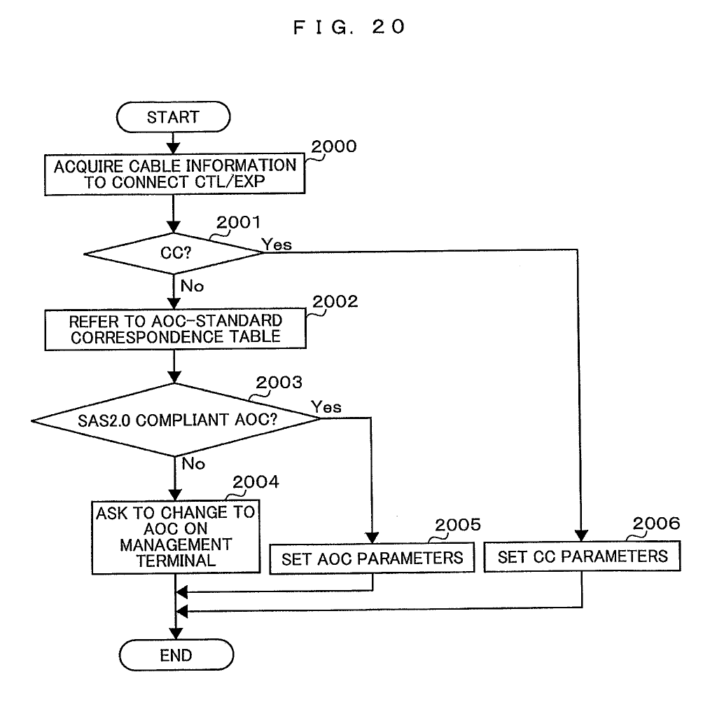

The disk array system acquires the CABLE information connected to the SAS 2.0 based CTL/EXP. When it is identified as the SAS 2.0 compliant AOC, the only parameters are changed to the AOC parameters, while the CC protocol (SAS 2.0 based) setting as the protocol setting is unchanged. When the CABLE information is not the SAS 2.0 compliant AOC, the disk array system instructs to replace with the appropriate AOC on the management terminal. FIG. 20 shows the flow when the SAS 2.0 based CTL/EXP is used.

The MP 412 or the CTL 416 issues a CABLE information acquisition request to each EXP 421 by the CC protocol, and acquires the CABLE information to establish the CTL/EXP connection shown in FIG. 8 or FIG. 16 (2000). Then, the MP 412 or the CTL 416 determines whether the cable is CC (2001). When the cable is CC, the MP 412 or the CTL 416 sets the CC parameters (2006) and ends the process. If the cable is not CC, the MP 412 or the CTL 416 refers to the AOC standard correspondence table shown in FIG. 19 (2002), and determines whether the cable is the SAS 2.0 compliant AOC (2003). When the cable is the SAS 2.0 compliant AOC, the MP 412 or the CTL 416 sets the AOC parameters (2005) and ends the process. If the cable is not the SAS 2.0 compliant AOC, the MP 412 or the CTL 416 asks the management terminal 411 to change the AOC (2004).

### LIST OF REFERENCE SIGNS

41: DKC, 42: DKU, 411: Management terminal, 412: MP, 413: CHA, 414: SW, 415: CM, 416: CTL, 420: Drive BOX, 421: EXP, 423: Disk, 424: SSW, 425; MEM of EXP, 426: MEM of cable, 427; Cable

1. A disk array system for writing data to a plurality of memory devices or reading data from the plurality of memory devices, based on a request from a host computer,
wherein the disk array system includes:
a disk controller for receiving write/read requests to the memory device from the host computer, and exchanging data between the host computer and the memory device; and
a disk unit part provided with a plurality of daisy-chained drive boxes each having at least one built-in memory device, including disk access paths connected by different types of cables between the memory devices within the drive boxes, and between the drive boxes,
wherein the drive box has an expander connected to a control memory of which relays a first cable on the upstream side near the disk controller and a second cable on the downstream side opposite the disk controller and accesses the built-in memory device,
wherein each of the cables has a built-in memory provided in a connector on the upstream side of the cable and a connector on the downstream side of the cable, storing CABLE information including the cable type and the setting information of the protocol and parameters according to the cable type, and
wherein, based on the request from the disk controller, the expander acquires the CABLE information from the built-in memory, and sets the setting information according to the cable type into the own expander.

2. The disk array system according to claim 1,
wherein upon receiving a CABLE information acquisition request from the disk controller, the expander on the upstream side of the cable reads the cable type included in the CABLE information from the built-in memory on the upstream side of the cable, stores the read cable type in the control memory, transmits the read cable type to the disk controller, and instructs the expander on the downstream side of the cable to read and store the cable type, and
wherein the disk controller stores the cable type from the upstream expander, and identifies the type of the cable.

3. The disk array system according to claim 1,
wherein upon receiving the setting information acquisition request from the disk controller, the expander on the upstream side of the cable reads the setting information included in the CABLE information from the built-in memory on the upstream side of the cable, stores the read setting information in the control memory, transmits the read setting information to the disk controller, and instructs the expander on the downstream side of the cable to read and store the setting information, and
wherein the disk controller receives the setting information from the upstream expander, and stores the received setting information.

4. The disk array system according to claim 1,
wherein upon receiving the setting information setting request from the disk controller, the expander on the upstream side of the cable reads the setting information included in the CABLE information from the control memory on the upstream side of the cable, sets the read setting information in the own expander, instructs the expander on the downstream side of the cable to set the setting information, and transmits the completion of the setting information setting to the disk controller, and
wherein the disk controller receives the completion of the setting information from the upstream expander, and stores the received data.

5. The disk array system according to claim 4,
wherein when the expender on the upstream side of the cable reports to the disk controller that the setting information setting has been completed, the expender on the upstream side of the cable confirms the completion of the setting information setting received from the expander on the downstream side of the cable.

6. The disk array system according to claim 1,
wherein the setting information includes a protocol for data transmission, and parameters including a proper value of a signal amplitude as well as the emphasis.

7. The disk array system according to claim 1,
wherein the disk controller limits the target part of the cable type determination operation based on the configuration information of the memory device connection in the disk array system.

8. The disk array system according to claim 1,
wherein, in the CABLE information acquisition, the disk controller includes:
performing the initialization sequence to check the number of connected stages of the expander by a first cable type protocol;
when the expected value of the number of connected stages of the expander based on the configuration information of the memory device connection in the disk array system is different from the actual number of connected stages, repeating the initialization sequence by switching to a second cable type protocol of the expander at the last stage; and
when the number of retries of the initialization sequence reaches a predetermined number, notifying the management terminal device connected to the disk controller that the initialization sequence has failed.

9. The disk array system according to claim 8,
wherein, in the CABLE information acquisition, the disk controller limits the target part of the cable type determination operation to determine the necessity of the information acquisition, and then performs the initialization sequence according to claim 8 with respect to the target part requiring the information acquisition.

10. The disk array system according to claim 1,
wherein the disk controller includes:
storing a standard correspondence table between cable products and standards;
determining whether a particular cable corresponds to a specific standard based on the standard correspondence table;
when the particular cable corresponds to the specific standard, setting the parameters appropriate for the particular cable to the expander; and
when the particular cable does not correspond to the specific standard, transmitting a request to the management terminal device connected to the disk controller to change the cable.

11. A cable information setting method in a disk array system,
wherein the disk array system includes:
an expander included in each of a plurality of drive boxes each having at least one built-in memory device, the drive boxes being daisy-chained to form a disk unit part, including disk access paths connected by different types of cables between the memory devices within the drive boxes and between the drive boxes, for the number of multiplicity of the process, the expander including receiving write/read requests from a host computer to the memory device, relaying a first cable on the upstream side near a disk controller for exchanging data between the host computer and the memory device, and a second cable on the downstream side opposite the disk controller, and accessing the built-in memory device; and
a cable storing the CABLE information of the cable type, the setting information including the protocol and parameters according to the cable type, in a built-in memory provided in a upstream connector and a downstream connector, respectively, and
wherein the expander includes:
receiving a request from the disk controller;
acquiring the CABLE information from the built-in memory based on the request from the disk controller, and storing the acquired CABLE information in a control memory connected to the expander; and
setting the setting information according to the cable type stored in the control memory to the own expander.

12. The CABLE information setting method according to claim 11,
wherein the expander on the upstream side of the cable includes:
upon reception of the CABLE information acquisition request from the disk controller, reading the cable type included in the CABLE information from the built-in memory on the upstream side of the cable, and storing the read cable type in the control memory;
transmitting the read cable type to the disk controller; and
instructing the expander on the downstream side of the cable to read and store the cable type,
wherein the disk controller stores the cable type received from the upstream expander, and identifies the type of the cable.

13. The CABLE information setting method according to claim 11,
wherein the expander on the upstream side of the cable includes:
upon reception of the setting information acquisition request from the disk controller, reading the setting information included in the CABLE information from the built-in memory on the upstream side of the cable, and storing the read setting information in the control memory;
transmitting the read setting information to the disk controller; and
instructing the expander on the downstream side of the cable to read and store the setting information, and
wherein the disk controller receives the setting information from the upstream expander and stores the received setting information.

14. The CABLE information setting method according to claim 11,
wherein the expander on the upstream side of the cable includes:
upon reception of the setting information setting request from the disk controller, reading the setting information included in the CABLE information from the control memory on the upstream side of the cable, and setting the read setting information to the own expander;
instructing the expander on the downstream side of the cable to set the setting information; and
transmitting the completion of the setting of the setting information, and
wherein the disk controller receives the completion of the setting information from the upstream expander and stores the received data.

15. The CABLE information setting method according to claim 14,
wherein, when the expander on the upstream side of the cable reports to the disk controller that the setting information setting has been completed, the expander on the upstream side of the cable receives a setting completion report of the setting information from the expander on the downstream side of the cable, and confirms the received setting completion report.
